(19) United States
(12) Patent Application Publication
(10) Pub. No.: US 2018/0300336 A1
(43) Pub. Date: Oct. 18, 2018

(54) KNOWLEDGE POINT STRUCTURE-BASED SEARCH APPARATUS

(71) Applicants: HONG TAN, SHANGHAI (CN); ZHENGFANG MA, SHANGHAI (CN)

(72) Inventors: HONG TAN, SHANGHAI (CN); ZHENGFANG MA, SHANGHAI (CN)

(21) Appl. No.: 15/740,930

(22) PCT Filed: Jul. 7, 2016
(86) PCT No.: PCT/CN2016/089003

§ 371 Date: Jun. 9, 2018

(30) Foreign Application Priority Data
Jul. 8, 2015 (CN) 201510397801.0

(51) Int. Cl. G06F 17/30; G06N 5/02

(52) U.S. Cl. CPC G06F 17/3053; G06N 5/02; G06F 17/30342; G06F 17/30867

(57) ABSTRACT

A knowledge point structure-based search apparatus, which provides multiple search results, and prioritizes the search results based on sharing frequency. Further, users can interact with each other based on sharing. The technical solution is as follows: users are allowed to construct their own knowledge point structures based on their own understandings, and, a server provides multiple search results to different users separately in response to search requests submitted by the users, and prioritizes the search results by the number of clicks. Generally, a search result having the greatest number of clicks is more acceptable to the general public. Therefore, the users can obtain the best search result with minimum time and efforts. In addition, because a relation is established between a user clicking a search result and a user to which the search result belongs, for example, following and being followed, the related users can interact with each other.

### BACKGROUND OF THE PRESENT INVENTION

### Field of Invention

The present invention relates to a search system, specifically to a network apparatus for searching for content in a knowledge point structure.

### Description of Related Arts

Knowledge is usually categorized in network learning, and the elementray unit of an entire knowledge system is referred to as a knowledge point. For example, a knowledge point in Baidupedia is also referred to as an entry. Logical relationship such as a parallel relation, an inclusion relation, and a causal relation may exist between multiple knowledge points.

Conventional network learning is also learning based on knowledge points, but the knowledge points are basically displayed in text list form. For example, in Baidupedia, after users obtain a related vocabulary entry by inputting a search term, Baidupedia displays content, editor information and the like of the vocabulary entry on the page, and also displays vocabulary entries related to the vocabulary entry. The related entries generally appear in the content of the entry, and are provided by means of a network link. The users click the link to enter the entry corresponding to the link.

However, such a search manner in Baidupedia has the following several defects:

(1) A relation between entries in Baidupedia is a very weak connection, and the vocabulary entries basically have no strong logical relation, because the connection is established only when another entry is encountered in the explanation for the current entry. If the users need to dedicatedly learn a category of knowledge, the user cannot learn the knowledge in such manner as Baidupedia, because no logical relation exists between entries to learn, and no knowledge system can be constructed for the users.

(2) The explanations for entries and relations between the entries are mostly official definitions of Baidupedia, the users basically can only read, but cannot reconstruct the entries, such as reediting entry content, reediting entry categories, and reediting entry relations, based on their own understandings.

(3) The users have their own understandings for the same knowledge point, the system like Baidupedia lacks of sharing of an understanding on knowledge points between the users, and lacks of mutual communication between the users. This violates the spirit of user's social communication being the mainstream on the current Internet.

### SUMMARY OF THE PRESENT INVENTION

A brief overview of one or more aspects is given below to provide a basic understanding on the aspects. The overview is not a detailed general overview of all conceived aspects, is not intended to identify the critical or conclusive element of all aspects, and is also not intended to define the scope of any aspect or all aspects. The only objective is to give some concepts of one or more aspects in a simplified form to later give a more detailed description sequence.

The objective of the present invention is to resolve the foregoing problem, provide a knowledge point structure-based search apparatus, provide multiple search results, and prioritize the search results based on the sharing frequency. Further, users can interact with each other based on sharing.

The technical solution of the present invention is as follows: the present invention discloses a knowledge point structure-based search apparatus, comprising a network terminal and a server, wherein:

the network terminal comprises:

a search request module, used for users inputting a knowledge point for searching, and submitting, by using a first transmission module, search requests to the server for processing;

a knowledge point structure constructing module, used for the users constructing their own knowledge point structure, where the knowledge point structure comprises categories, relations, labels, and content of knowledge points, and uploading, by using the first transmission module, the constructed knowledge point structures to the server for storage; and

the first transmission module, used for transmitting data with the server; and

the server comprises:

a search processing module, used for searching in a knowledge point storage module of the server based on the search requests uploaded by the network terminal, and feeding back search results to the network terminal by using a second transmission module;

the knowledge point storage module, used for storing the knowledge point structures constructed by each of the users; and

the second transmission module, used for transmitting data with the network terminal.

According to an embodiment of the knowledge point structure-based search apparatus of the present invention, the search processing module comprises:

a search result prioritizing unit, used for prioritizing the search results.

According to an embodiment of the knowledge point structure-based search apparatus of the present invention, the network terminal further comprises:

a user learning record module, used for storing reading records of the users.

According to an embodiment of the knowledge point structure-based search apparatus of the present invention, the knowledge point structure constructing module comprises:

a knowledge point category constructing unit, used for editing a category to which a current knowledge point belongs;

a knowledge point content constructing unit, used for editing a label and content of the knowledge point; and

a knowledge point relation constructing unit, used for editing a relation between the current knowledge point and other knowledge points.

According to an embodiment of the knowledge point structure-based search apparatus of the present invention, the knowledge point structure constructing module further comprises:

a third-party knowledge point constructing unit, used for editing a knowledge point belonging to a third party.

According to an embodiment of the knowledge point structure-based search apparatus of the present invention, the search processing module comprises:

a single knowledge point search unit, used for searching, by using a single knowledge point as an input, for labels and content of knowledge points that match the single knowledge point.

According to an embodiment of the knowledge point structure-based search apparatus of the present invention, the search processing module comprises:

a knowledge point category search unit, used for searching, by using a single knowledge point as an input, for a category to which the single knowledge point belongs.

According to an embodiment of the knowledge point structure-based search apparatus of the present invention, the search processing module comprises:

a knowledge point relation search unit, used for searching, by using at least two knowledge points as an input, for a relationship between the at least two knowledge points; or searching, by using a single knowledge point as an input, for other knowledge points related to the single knowledge point.

According to an embodiment of the knowledge point structure-based search apparatus of the present invention, the search result prioritizing unit is used for prioritizing the search results in descending order by the number of clicks.

According to an embodiment of the knowledge point structure-based search apparatus of the present invention, the search result prioritizing unit is used for prioritizing the search results based on a Page Rank algorithm of the knowledge points.

According to an embodiment of the knowledge point structure-based search apparatus of the present invention, the network terminal comprises:

a user following module, used for following knowledge point labels, knowledge point relations, or knowledge point categories belonging to other users in the search results, and uploading the following information to the server.

According to an embodiment of the knowledge point structure-based search apparatus of the present invention, the server comprises:

a contribution storage module, used for storing a followed object of a knowledge point label, a knowledge point category, and a knowledge point relation belonging to each user in a knowledge point structure.

Compared with the prior art, the present invention has the following beneficial effect: The present invention may allow users to construct their own knowledge point structures based on their own understandings, and a server provides multiple search results to different users separately in response to a search request submitted by the users, and prioritizes the search results by the number of clicks. Generally, a search result having the greatest number of clicks is more acceptable to the general public. Therefore, the users can obtain the best search result with minimum time and efforts. In addition, because a relation is established between a user clicking a search result and a user to which the search result belongs (following and being followed), the related users can interact with each other. The search apparatus of the present invention may serve as a platform, one end is used for inputting by users, and the other end is used for connecting to a third-party knowledge point structure system (such as Baidupedia). A knowledge point belonging to the third-party knowledge point structure system may be provided to the users by the search apparatus of the present invention. That is, the search apparatus of the present invention may have an effect of bridges between the users and the third-party knowledge point structure.

### BRIEF DESCRIPTION OF THE DRAWINGS

FIG. 1 is a principle diagram of a first embodiment of a knowledge point structure-based search apparatus of the present invention.

FIG. 2 is a principle diagram of a second embodiment of a knowledge point structure-based search apparatus of the present invention.

FIG. 3 is a principle diagram of a third embodiment of a knowledge point structure-based search apparatus of the present invention.

FIG. 4 is a principle diagram of a fourth embodiment of a knowledge point structure-based search apparatus of the present invention.

FIG. 5 is a principle diagram of a fifth embodiment of a knowledge point structure-based search apparatus of the present invention.

FIG. 6 is a principle diagram of a sixth embodiment of a knowledge point structure-based search apparatus of the present invention.

FIG. 7 is a principle diagram of a seventh embodiment of a knowledge point structure-based search apparatus of the present invention.

### DETAILED DESCRIPTION OF THE PREFERRED EMBODIMENTS

After the detailed description of the embodiments of this disclosure is read with reference to the following accompanying drawings, the foregoing features and advantages of the present invention can be better understood. In the accompanying drawings, components are not necessarily drawn to scale, and components with similar related characteristics or features may have same or similar reference numbers.

### First Embodiment of a Knowledge Point Structure-Based Search Apparatus

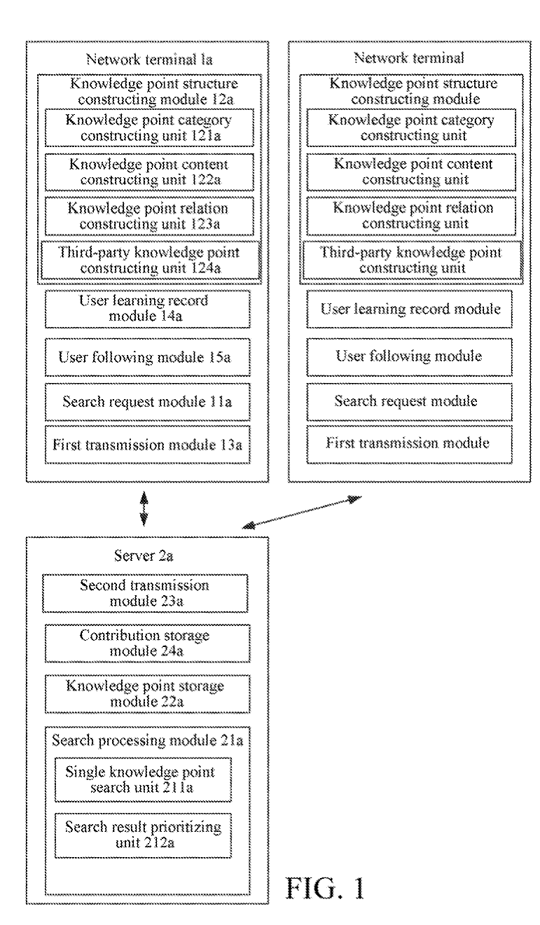

FIG. 1 shows a principle of a first embodiment of a knowledge point structure-based search apparatus of the present invention. Referring to FIG. 1, the knowledge point structure-based search apparatus of this embodiment comprises a network terminal 1a and a server 2a. The network terminal 1a comprises a search request module 11a, a knowledge point structure constructing module 12a, and a first transmission module 13a. The server 2a comprises a search processing module 21a, a knowledge point storage module 22a, and a second transmission module 23a.

The first transmission module 13a of the network terminal 1a transmits data with the server 2a, and the second transmission module 23a of the server 2a transmits data with the network terminal 1a.

In the knowledge point structure constructing module 12a of the network terminal 1a, users may construct their own knowledge point structures based on knowledge points, electronic books, teaching materials and the like that have been read. The knowledge point structure comprises categories, relations, labels, and content of knowledge points. Correspondingly, the knowledge point structure constructing module 12a comprises a knowledge point category constructing unit 121a, a knowledge point content constructing unit 122a, and a knowledge point relation constructing unit 123a.

The knowledge point category constructing unit 121a is for editing a category to which a current knowledge point belongs. The category of the knowledge point refers to the category defined on the knowledge point by an editor of the knowledge point. For example, “Belt and Road” is defined to the “economics” category under the editing of user A, but may be defined to the “politics” category under the editing of user B. Different users may define a same knowledge point to different categories because of their different understandings.

The knowledge point content constructing unit 122a is used for editing a label and content of the knowledge point. The label of the knowledge point is similar to a name of the knowledge point, for example, “Belt and Road” is the label of the knowledge point. The content of the knowledge point is the specific definition on the knowledge point, for example, what Belt and Road specifically refers to is the content of the “Belt and Road” label.

The knowledge point relation constructing unit 123a is used for editing a relation between the current knowledge point and other knowledge points. The relation herein refers to a logical relation between knowledge points, and such logical relation may be preferably represented by a tree data structure. A parent-child node is used to represent a hyponymy relation between knowledge points, and a brother node is used to represent a parallel relation between knowledge points. For example, a parent node of “Belt and Road” is “national strategies”, child nodes of “Belt and Road” are “Silk Road Economic Belt”, “Maritime Silk Road”, and “AIIB”, and brother nodes of “Belt and Road” are “Beijing-Tianjin-Hebei Integration”, “Yangtze River Economic Zone”, “Free Trade Zone”, “Western Development”, “Northeast Revitalization”, and the like.

In addition, preferably, the knowledge point structure constructing module 12a further comprises a third-party knowledge point constructing unit 124a, which is used for editing a knowledge point belonging to a third party. For example, the users may edit the knowledge points in Baidupedia by the unit, and add the knowledge points to their own knowledge point structures.

For the labels and content of the knowledge points, the categories of the knowledge points, and the relations of the knowledge points, the users may set a public attribution of related information that belongs to their own knowledge points, for example, only visible to the users, only visible to fans, or completely public.

Data of the knowledge point structure (comprising the categories, the relationships, the labels, and the content of the knowledge points) is uploaded, by using the first transmission module 13a, to the server 2a for storage.

Preferably, besides the knowledge point structures processed by the users, the network terminal 1a may further provide a function of recording user's learning processes. For example, a user learning record module 14a is provided in the network terminal 1a, and is used for storing reading records of the users, comprising knowledge points, electronic books, PPT teaching materials and the like that have been read. Generally, the reading records of the users are stored according to a time sequence, and besides being stored locally, the records may be further uploaded, by the first transmission module 13a, to the server 2a for storage.

Data uploaded by many network terminals 1a and belonging to a knowledge point structure constructed by each user is uniformly stored in the knowledge point storage module 22a of the server 2a.

The users may search the network terminal 1a, and input a search condition for a target knowledge point by the search request module 11a. The system generates a search request based on the search condition, and uploads the search request to the server 2a by the first transmission module 13a.

The search processing module 21a of the server 2a processes the search request, searches the knowledge point storage module 22a based on the search request, and transmits back a search result to the network terminal 1a by using the second transmission module 23a.

In this embodiment, the search processing module 21a comprises a single knowledge point search unit 211. The single knowledge point search unit 211a searches, by using a single knowledge point as an input condition, for labels and content of knowledge points that match the single knowledge point.

Because all the users have their own knowledge point structures on the server, multiple search results may exist. For example, when the users input the knowledge point of “AIIB”, three search results are generated. The first one is a knowledge point constructed by user A, the content of “AIIB” is obtained when user A reads an economics electronic book, and user A uses the definition of “AIIB” in the electronic book as the content of the knowledge point. The second one is a knowledge point constructed by user B, the content of “AIIB” is obtained when user B reads a current politics electronic magazine, and user B uses the definition of “AIIB” in the electronic magazine as the content of the knowledge point. The third one is a vocabulary entry of “AIIB” from the third-party Baidupedia.

Certainly, among the knowledge points provided by the users or the third party, the system may provide one of the knowledge points which is approved by the system as the recommended knowledge point to the users.

The server 2a feeds back all search results to the network terminal 1a. Preferably, a search result prioritizing unit 212a is provided in the search processing module 21a, to prioritize the search results in a preset prioritizing condition. In this embodiment, by the number of clicks of the knowledge points, all found knowledge points are prioritized in descending order and then output. Therefore, the users can see, on the network terminal 1a, all knowledge points of “AIIB” obtained through search, and the knowledge points prioritized by the number of clicks by the users. Preferably, the number of clicks may be marked in the search results. Alternatively, the search result prioritizing unit 212a performs prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

A user following module 15a which is used for following satisfied knowledge point labels and content after the users finish reading the knowledge points in the search results may be further designed on the network terminal 1a. The following behavior is automatically uploaded to the server 2a for storage. Correspondingly, the contribution storage module 24a of the server 2a updates followed objects of the knowledge point labels and content in the knowledge point structure to which corresponding users belong, where the labels and content are stored in the contribution storage module 24a.

On this basis, a relationship is established between a user following a knowledge point and a user to which the knowledge point belongs. The system may use the relationship to make users interact with each other, thereby establishing a social relation on the network.

Moreover, if the users select, from the search results, a knowledge point provided by a third party, the search apparatus of the present invention will be a bridge and an intermediation platform between the users and a third-party knowledge point provider which directly links to the third party, for example, Baidupedia or other search websites.

### A Second Embodiment of a Knowledge Point Structure-Based Search Apparatus

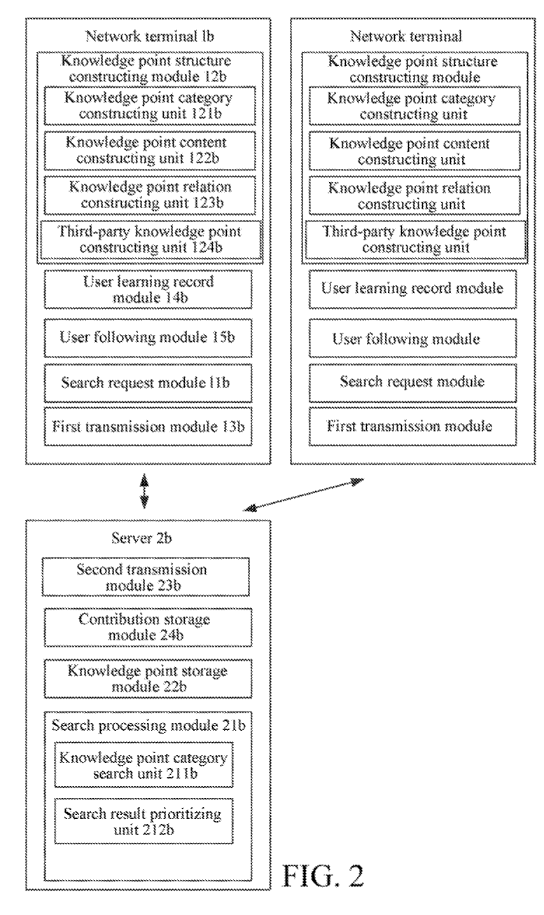

FIG. 2 shows a principle of a second embodiment of a knowledge point structure-based search apparatus of the present invention. Referring to FIG. 2, the knowledge point structure-based search apparatus of this embodiment comprises a network terminal 1b and a server 2b. The network terminal 1b comprises a search request module 11b, a knowledge point structure constructing module 12b, and a first transmission module 13b. The server 2b comprises a search processing module 21b, a knowledge point storage module 22b, and a second transmission module 23b.

The first transmission module 13b of the network terminal 1b transmits data with the server 2b, and the second transmission module 23b of the server 2b transmits data with the network terminal 1b.

In the knowledge point structure constructing module 12b of the network terminal 1b, users may construct their own knowledge point structures based on knowledge points, electronic books, teaching materials and the like that have been read. The knowledge point structure comprises categories, relations, labels, and content of knowledge points. Correspondingly, the knowledge point structure constructing module 12b comprises a knowledge point category constructing unit 121b, a knowledge point content constructing unit 122b, and a knowledge point relation constructing unit 123b.

The knowledge point category constructing unit 121b is used for editing a category to which a current knowledge point belongs. The category of the knowledge point refers to the category defined on the knowledge point by an editor of the knowledge point. For example, “Belt and Road” is defined to the “economics” category under the editing of user A, but may be defined to the “politics” category under the editing of user B. Different users may define a same knowledge point to different categories because of their different understandings.

The knowledge point content constructing unit 122b is used for editing a label and content of the knowledge point. The label of the knowledge point is similar to a name of the knowledge point, for example, “Belt and Road” is the label of the knowledge point. The content of the knowledge point is the specific definition on the knowledge point, for example, what Belt and Road specifically refers to is the content of the “Belt and Road” label.

The knowledge point relation constructing unit 123b is used for editing a relation between the current knowledge point and other knowledge points. The relation herein refers to a logical relation between knowledge points, and such logical relation may be preferably represented by a tree data structure. A parent-child node is used to represent a hyponymy relation between knowledge points, and a brother node is used to represent a parallel relation between knowledge points. For example, a parent node of “Belt and Road” is the “national strategies”, child nodes of “Belt and Road” are “Silk Road Economic Belt”, “Maritime Silk Road”, and “AIIB”, and brother nodes of “Belt and Road” are “Beijing-Tianjin-Hebei Integration”, “Yangtze River Economic Zone”, “Free Trade Zone”, “Western Development”, “Northeast Revitalization”, and the like.

In addition, preferably, the knowledge point structure constructing module 12b further comprises a third-party knowledge point constructing unit 124a, which is used for editing a knowledge point belonging to a third party. For example, the users may edit the knowledge points in Baidupedia by the unit, and add the knowledge points to their own knowledge point structures.

For the labels and content of the knowledge points, the categories of the knowledge points, and the relations of the knowledge points, the users may set a public attribution of related information that belongs to their own knowledge points, for example, only visible to the users, only visible to fans, or completely public.

Data of the knowledge point structure (comprising the categories, the relationships, the labels, and the content of the knowledge points) is uploaded, by using the first transmission module 13b, to the server 2b for storage.

Preferably, besides the knowledge point structures processed by the users, the network terminal 1b may further provide a function of recording user's learning processes. For example, a user learning record module 14b is provided in the network terminal 1b, and is used for storing reading records of the users, comprising knowledge points, electronic books, PPT teaching materials and the like that have been read. Generally, the reading records of the users are stored according to a time sequence, and besides being stored locally, the records may be further uploaded, by the first transmission module 13b, to the server 2b for storage.

Data uploaded by many network terminals 1b and belonging to a knowledge point structure constructed by each user is uniformly stored in the knowledge point storage module 22b of the server 2b.

The users may search the network terminal 1b, and input a search condition for a target knowledge point by the search request module 11b. The system generates a search request based on the search condition, and uploads the search request to the server 2b by the first transmission module 13b.

The search processing module 21b of the server 2b processes the search request, searches the knowledge point storage module 22b based on the search request, and transmits back a search result to the network terminal 1b by using the second transmission module 23b.

In this embodiment, the search processing module 21b comprises a knowledge point category search unit 211b. The knowledge point category search unit 211b searches, by using a single knowledge point as an input, for a category to which the single knowledge point belongs.

Because all the users have their own knowledge point structures on the server, multiple search results may exist. For example, when the users input the knowledge point of “AIIB”, three search results are generated. The first one is a knowledge point constructed by user A, the content of “AIIB” is obtained when user A reads an economics electronic book, and user A classifies “AIIB” into the “economics” category. The second one is a knowledge point constructed by user B, the content of “AIIB” is obtained when user B reads a current politics electronic magazine, and user B classifies “AIIB” into the “politics category. The third one is a category of “AIIB” from the third-party Baidupedia, and the category is “national strategies”.

Certainly, among the knowledge point categories provided by the users or the third party, the system may provide one of the knowledge point categories which is approved by the system as the recommended knowledge point to the users.

The server 2b feeds back all search results to the network terminal 1b. Preferably, a search result prioritizing unit 212b is provided in the search processing module 21b, to prioritize the search results in a preset prioritizing condition. In this embodiment, by the number of clicks of the knowledge point categories, all found knowledge point categories are prioritized in descending order and then output. Therefore, the users can see, on the network terminal 1b, all categories of “AIIB” obtained through search, and the categories prioritized by the number of clicks by the users. Preferably, the number of clicks may be marked in the search results. Alternatively, the search result prioritizing unit 212b performs prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

A user following module 15b which is used for following satisfied knowledge point categories after the users finish reading the knowledge point categories in the search results may be further designed on the network terminal 1b. The following behavior is automatically uploaded to the server 2b for storage. Correspondingly, the contribution storage module 24b of the server 2b updates followed objects of the knowledge point categories in the knowledge point structure to which corresponding users belong, where the categories are stored in the contribution storage module 24b.

On this basis, a relationship is established between a user following a knowledge point category and a user to which the knowledge point category belongs. The system may use the relationship to make users interact with each other, thereby establishing a social relation on the network.

Moreover, if the users select, from the search results, a knowledge point category provided by a third party, the search apparatus of the present invention will be a bridge and an intermediation platform between the users and a third-party knowledge point provider which directly links to the third party, for example, Baidudia or other search websites.

### A Third Embodiment of a Knowledge Point Structure-Based Search Apparatus

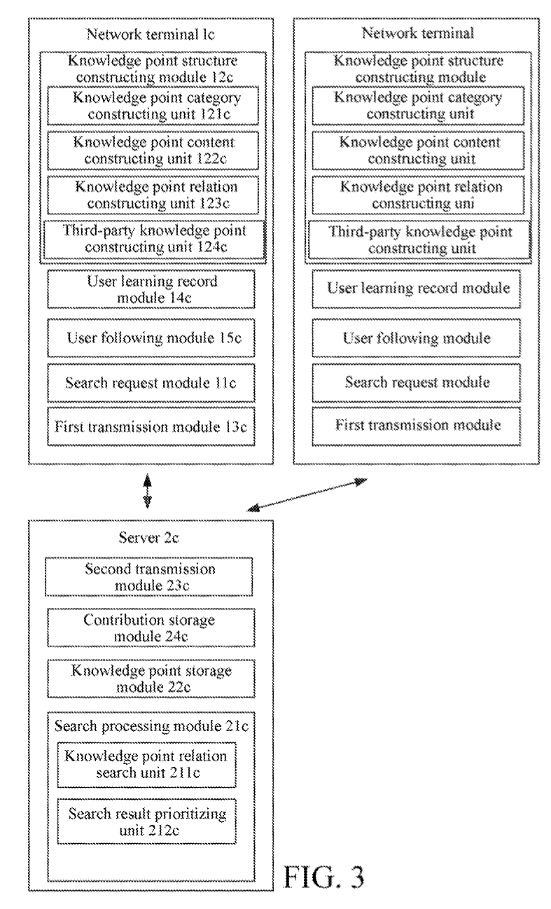

FIG. 3 shows a principle of a third embodiment of a knowledge point structure-based search apparatus of the present invention. Referring to FIG. 3, the knowledge point structure-based search apparatus of this embodiment comprises a network terminal 1c and a server 2c. The network terminal 1c comprises a search request module 11c, a knowledge point structure constructing module 12c, and a first transmission module 13c. The server 2c comprises a search processing module 21c, a knowledge point storage module 22c, and a second transmission module 23c.

The first transmission module 13c of the network terminal 1c transmits data with the server 2c, and the second transmission module 23c of the server 2c transmits data with the network terminal 1c.

In the knowledge point structure constructing module 12c of the network terminal 1c, users may construct their own knowledge point structures based on knowledge points, electronic books, teaching materials and the like that have been read. The knowledge point structure comprises categories, relations, labels, and content of knowledge points. Correspondingly, the knowledge point structure constructing module 12c comprises a knowledge point category constructing unit 121c, a knowledge point content constructing unit 122c, and a knowledge point relation constructing unit 123c.

The knowledge point category constructing unit 121c is for editing a category to which a current knowledge point belongs. The category of the knowledge point refers to the category defined on the knowledge point by an editor of the knowledge point. For example, “Belt and Road” is defined to the “economics” category under the editing of user A, but may be defined to the “politics” category under the editing of user B. Different users may define a same knowledge point to different categories because of their different understandings.

The knowledge point content constructing unit 122c is used for editing a label and content of the knowledge point. The label of the knowledge point is similar to a name of the knowledge point, for example, “Belt and Road” is the label of the knowledge point. The content of the knowledge point is the specific definition on the knowledge point, for example, what the Belt and Road specifically refers to is the content of the “Belt and Road” label.

The knowledge point relation constructing unit 123c is used for editing a relation between the current knowledge point and other knowledge points. The relation herein refers to a logical relation between knowledge points, and such logical relation may be preferably represented by a tree data structure. A parent-child node is used to represent a hyponymy relation between knowledge points, and a brother node is used to represent a parallel relation between knowledge points. For example, a parent node of “Belt and Road” is the “national strategies”, child nodes of “Belt and Road” are “Silk Road Economic Belt”, “Maritime Silk Road”, and “AIIB”, and brother nodes of “Belt and Road” are “Beijing-Tianjin-Hebei Integration”, “Yangtze River Economic Zone”, “Free Trade Zone”, “Western Development”, “Northeast Revitalization”, and the like.

In addition, preferably, the knowledge point structure constructing module 12c further comprises a third-party knowledge point constructing unit 124c, which is used for editing a knowledge point belonging to a third party. For example, the users may edit the knowledge points in Baidupedia by the unit, and add the knowledge points to their own knowledge point structures.

For the labels and content of the knowledge points, the categories of the knowledge points, and the relations of the knowledge points, the users may set a public attribution of related information that belongs to their own knowledge points, for example, only visible to the users, only visible to fans, or completely public.

Data of the knowledge point structure (comprising the categories, the relationships, the labels, and the content of the knowledge points) is uploaded, by using the first transmission module 13c, to the server 2c for storage.

Preferably, besides the knowledge point structures processed by the users, the network terminal 1c may further provide a function of recording user's learning processes. For example, a user learning record module 14c is provided in the network terminal 1c, and is used for storing reading records of the users, comprising knowledge points, electronic books, PPT teaching materials and the like that have been read. Generally, the reading records of the users are stored according to a time sequence, and besides being stored locally, the records may be further uploaded, by the first transmission module 13c, to the server 2c for storage.

Data uploaded by many network terminals 1c and belonging to a knowledge point structure constructed by each user is uniformly stored in the knowledge point storage module 22c of the server 2c.

The users may search the network terminal 1c, and input a search condition for a target knowledge point by the search request module 11c. The system generates a search request based on the search condition, and uploads the search request to the server 2c by the first transmission module 13c.

The search processing module 21c of the server 2c processes the search request, searches the knowledge point storage module 22c based on the search request, and transmits back a search result to the network terminal 1c by using the second transmission module 23c.

In this embodiment, the search processing module 21c comprises a knowledge point relation search unit 211c. The knowledge point relation search unit 211c searches, by using at least two knowledge points as an input, for a relationship between the at least two knowledge points. Alternatively, the knowledge point relation search unit 211c searches, by using a single knowledge point as an input, for other knowledge points related to the single knowledge point. The relationship may not be limited, which may be, for example, a parent node knowledge point, a child node knowledge point, or a brother node knowledge point; or the relationship may be limited, which may be, for example, specifically limited to a parent node knowledge point, a child node knowledge point, or a brother node knowledge point.

Because all the users have their own knowledge point structures on the server, multiple search results may exist. For example, when the users input “AIIB Belt and Road”, three search results are generated. The first one is a knowledge point relation constructed by user A, “AIIB” and “Belt and Road” are in a parent-child relation, wherein “Belt and Road” is a parent node, “AIIB” is a child node. The second one is a knowledge point relation constructed by user B, “AIIB” and “Belt and Road” are in a brother relation. The third one is a skip parallel relation from the third-party Baidupedia. Certainly, the relation between “AIIB” and “Belt and Road” may not be found, in this case, the search result will represent “no relation”.

Certainly, among the knowledge point relations provided by the users or the third party, the system may provide one of the knowledge point relations which ise approved by the system as the recommended knowledge point relation to the users.

The server 2c feeds back all search results to the network terminal 1c. Preferably, a search result prioritizing unit 212c is provided in the search processing module 21c, to prioritize the search results in a preset prioritizing condition. In this embodiment, by the number of clicks of the knowledge point relations, all found knowledge point relations are prioritized in descending order and then output. Therefore, the users can see, on the network terminal 1c, all relations between “AIIB” and “Belt and Road” obtained through search, and the relations prioritized by the number of clicks by the users. Preferably, the number of clicks may be marked in the search results. Alternatively, the search result prioritizing unit 212c performs prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

A user following module 15c, which is used for following satisfied knowledge point relations after the users finish reading the knowledge point relations in the search results may be further designed on the network terminal 1c. The following behavior is automatically uploaded to the server 2c for storage. Correspondingly, the contribution storage module 24c of the server 2c updates followed objects of the knowledge point relations in the knowledge point structure to which corresponding users belong, where the relations are stored in the contribution storage module 24c.

On this basis, a relationship is established between a user following a knowledge point relation and a user to which the knowledge point relation belongs. The system may use the relationship to make users interact with each other, thereby establishing a social relation on the network.

Moreover, if the users select, from the search results, a knowledge point relation provided by a third party, the search apparatus of the present invention will be a bridge and an intermediation platform between the users and a third-party knowledge point provider which directly links to the third party, for example, Baidupedia or other search websites.

### A Fourth Embodiment of a Knowledge Point Structure-Based Search Apparatus

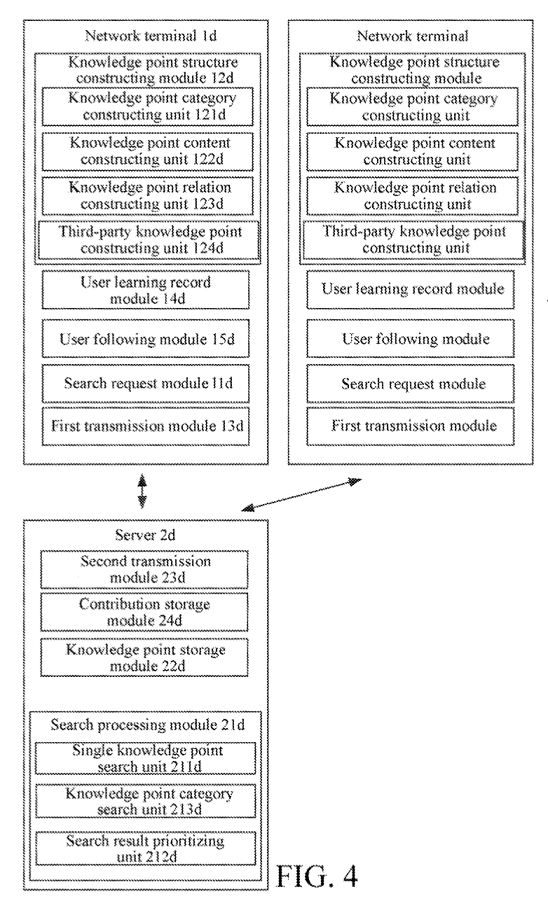

FIG. 4 shows a principle of a fourth embodiment of a knowledge point structure-based search apparatus of the present invention. Referring to FIG. 4, the knowledge point structure-based search apparatus of this embodiment comprises a network terminal 1d and a server 2d. The network terminal 1d comprises a search request module 11d, a knowledge point structure constructing module 12d, and a first transmission module 13d. The server 2d comprises a search processing module 21d, a knowledge point storage module 22d, and a second transmission module 23d.

The first transmission module 13d of the network terminal 1d transmits data with the server 2d, and the second transmission module 23d of the server 2d transmits data with the network terminal 1d.

In the knowledge point structure constructing module 12d of the network terminal 1d, users may construct their own knowledge point structures based on knowledge points, electronic books, teaching materials and the like that have been read. The knowledge point structure comprises categories, relations, labels, and content of knowledge points. Correspondingly, the knowledge point structure constructing module 12d comprises a knowledge point category constructing unit 121d, a knowledge point content constructing unit 122d, and a knowledge point relation constructing unit 123d.

The knowledge point category constructing unit 121d is used for editing a category to which a current knowledge point belongs. The category of the knowledge point refers to the category defined on the knowledge point by an editor of the knowledge point. For example, “Belt and Road” is defined to the “economics” category under the editing of user A, but may be defined to the “politics” category under the editing of user B. Different users may define a same knowledge point to different categories because of their different understandings.

The knowledge point content constructing unit 122d is used for editing a label and content of the knowledge point. The label of the knowledge point is similar to a name of the knowledge point, for example, “Belt and Road” is the label of the knowledge point. The content of the knowledge point is the specific definition on the knowledge point, for example, what the Belt and Road specifically refers to is the content of the “Belt and Road” label.

The knowledge point relation constructing unit 123d is used for editing a relation between the current knowledge point and other knowledge points. The relation herein refers to a logical relation between knowledge points, and such logical relation may be preferably represented by a tree data structure. A parent-child node is used to represent a hyponymy relation between knowledge points, and a brother node is used to represent a parallel relation between knowledge points. For example, a parent node of “Belt and Road” is the “national strategies”, child nodes of “Belt and Road” are “Silk Road Economic Belt”, “Maritime Silk Road”, and “AIIB”, and brother nodes of “Belt and Road” are “Beijing-Tianjin-Hebei Integration”, “Yangtze River Economic Zone”, “Free Trade Zone”, “Western Development”, “Northeast Revitalization”, and the like.

In addition, preferably, the knowledge point structure constructing module 12d further comprises a third-party knowledge point constructing unit 124d, which is used for editing a knowledge point belonging to a third party. For example, the users may edit the knowledge points in Baidupedia by the unit, and add the knowledge points to their own knowledge point structures.

For the labels and content of the knowledge points, the categories of the knowledge points, and the relations of the knowledge points, the users may set a public attribution of related information that belongs to their own knowledge points, for example, only visible to the users, only visible to fans, or completely public.

Data of the knowledge point structure (comprising the categories, the relationships, the labels, and the content of the knowledge points) is uploaded, by using the first transmission module 13d, to the server 2d for storage.

Preferably, besides the knowledge point structures processed by the users, the network terminal 1d may further provide a function of recording user's learning processes. For example, a user learning record module 14d is provided in the network terminal 1d, and is used for storing reading records of the users, comprising knowledge points, electronic books, PPT teaching materials and the like that have been read. Generally, the reading records of the users are stored according to a time sequence, and besides being stored locally, the records may be further uploaded, by the first transmission module 13d, to the server 2d for storage.

Data uploaded by many network terminals 1d and belonging to a knowledge point structure constructed by each user is uniformly stored in the knowledge point storage module 22d of the server 2d.

The users may search the network terminal 1d, and input a search condition for a target knowledge point by the search request module 11d. The system generates a search request based on the search condition, and uploads the search request to the server 2d by the first transmission module 13d.

The search processing module 21d of the server 2d processes the search request, searches the knowledge point storage module 22d based on the search request, and transmits back a search result to the network terminal 1d by using the second transmission module 23d.

In this embodiment, the search processing module 21d comprises a single knowledge point search unit 211d and a knowledge point category search unit 213d.

The single knowledge point search unit 211d searches, by using a single knowledge point as an input condition, for labels and content of knowledge points that match the single knowledge point.

Because all users have their own knowledge point structures on the server, multiple search results may exist. For example, when the users input the knowledge point of “AIIB”, three search results are generated. The first one is a knowledge point constructed by user A, the content of “AIIB” is obtained when user A reads an economics electronic book, and user A uses the definition of “AIIB” in the electronic book as the content of the knowledge point. The second one is a knowledge point constructed by user B, the content of “ AIIB” is obtained when user B reads a current politics electronic magazine, and user B uses the definition of “AIIB” in the electronic magazine as the content of the knowledge point. The third one is a vocabulary entry of “AIIB” from the third-party Baidupedia.

Certainly, among the knowledge points provided by the users or the third party, the system may provide one of the knowledge points which is approved by the system as the recommended knowledge point to the users.

The server 2d feeds back all search results to the network terminal 1d. Preferably, a search result prioritizing unit 212d is provided in the search processing module 21d, to prioritize the search results in a preset prioritizing condition. In this embodiment, by the number of clicks of the knowledge points, all found knowledge points are prioritized in descending order and then output. Therefore, the users can see, on the network terminal 1d, all knowledge points of “AIIB” obtained through search, and the knowledge points prioritized by the number of clicks by the users. Preferably, the number of clicks may be marked in the search results. Alternatively, the search result prioritizing unit 212d performs prioritizing based on a PageRank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

A user following module 15d which is used for following satisfied knowledge point labels and content after the users finish reading the knowledge points in the search results may be further designed on the network terminal 1d. The following behavior is automatically uploaded to the server 2d for storage. Correspondingly, the contribution storage module 24d of the server 2d updates followed objects of the knowledge point labels and content in the knowledge point structure to which corresponding users belong, where the labels and content are stored in the contribution storage module 24d.

On this basis, a relationship is established between a user following a knowledge point and a user to which the knowledge point belongs. The system may use the relationship to make users interact with each other, thereby establishing a social relation on the network.

Moreover, if the users select, from the search results, a knowledge point provided by a third party, the search apparatus of the present invention will be a bridge and an intermediation platform between the users and a third-party knowledge point provider which directly links to the third party, for example, Baidupedia or other search websites.

The knowledge point category search unit 213d searches, by using a single knowledge point as an input, for a category to which the single knowledge point belongs.

Because all the users have their own knowledge point structures on the server, multiple search results may exist. For example, when users input the knowledge point of “AIIB”, three search results are generated. The first one is a knowledge point constructed by user A, the content of “AIIB” is obtained when user A reads an economics electronic book, and user A classifies “AIIB” into the “economics” category. The second one is a knowledge point constructed by user B, the content of “ AIIB” is obtained when user B reads a current politics electronic magazine, and user B classifies “AIIB” into the “politics” category. The third one is a category of “AIIB” from the third-party Baidupedia, and the category is “national strategies”.

Certainly, among the knowledge point categories provided by the users or the third party, the system may provide one of the knowledge point categories which is approved by the system as the recommended knowledge point to the users.

The server 2d feeds back all search results to the network terminal 1d. The search result prioritizing unit 212d prioritizes the search results in a preset prioritizing condition. In this embodiment, by the number of clicks of the knowledge point categories, all found knowledge point categories are prioritized in descending order and then output. Therefore, the users can see, on the network terminal 1d, all categories of “AIIB” obtained through search, and the categories prioritized by the number of clicks by the users. Preferably, the number of clicks may be marked in the search results. Alternatively, the search result prioritizing unit 212d performs prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of PageRank. This is to extract valuable information from big data, to filter noise information. The users may also perform modification on the basis of reference to establish knowledge points of their own versions.

The user following module 15d follows satisfied knowledge point categories after the users finish reading the knowledge point categories in the search results. The following behavior is automatically uploaded to the server 2d for storage. Correspondingly, the contribution storage module 24d of the server 2d updates followed objects of the knowledge point categories in the knowledge point structure to which corresponding users belong, where the categories are stored in the contribution storage module 24d.

On this basis, a relationship is established between a user following a knowledge point category and a user to which the knowledge point category belongs. The system may use the relationship to make users interact with each other, thereby establishing a social relation on the network.

Moreover, if the users select, from the search results, a knowledge point category provided by a third party, the search apparatus of the present invention will be a bridge and an intermediation platform between the users and a third-party knowledge point provider which directly links to the third party, for example, Baidupedia or other search websites.

### A Fifth Embodiment of a Knowledge Point Structure-Based Search Apparatus

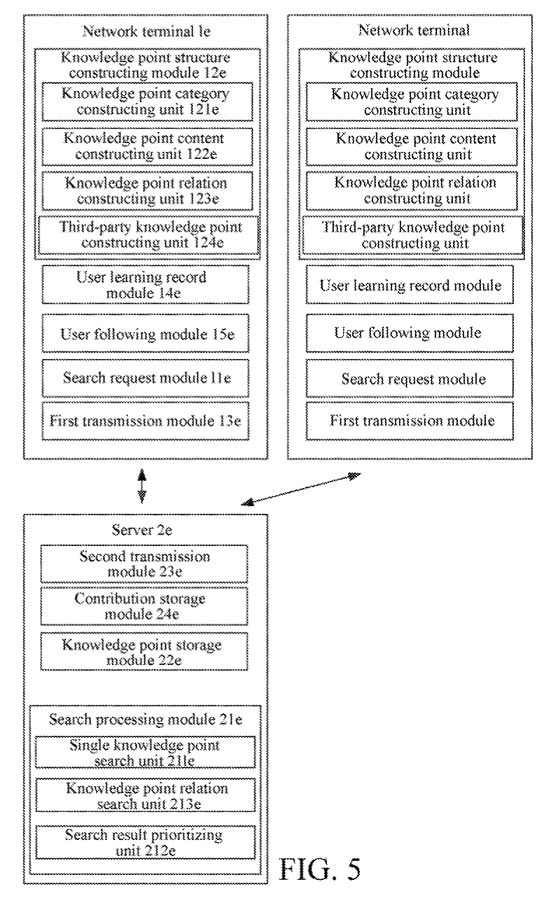

FIG. 5 shows a principle of a fifth embodiment of a knowledge point structure-based search apparatus of the present invention. Referring to FIG. 5, the knowledge point structure-based search apparatus of this embodiment comprises a network terminal 1e and a server 2e. The network terminal 1e comprises a search request module 11e, a knowledge point structure constructing module 12e, and a first transmission module 13e. The server 2e comprises a search processing module 21e, a knowledge point storage module 22e, and a second transmission module 23e.

The first transmission module 13e of the network terminal 1e transmits data with the server 2e, and the second transmission module 23e of the server 2e transmits data with the network terminal 1e.

In the knowledge point structure constructing module 12e of the network terminal 1e, users may construct their own knowledge point structures based on knowledge points, electronic books, teaching materials and the like that have been read. The knowledge point structure comprises categories, relations, labels, and content of knowledge points. Correspondingly, the knowledge point structure constructing module 12e comprises a knowledge point category constructing unit 121e, a knowledge point content constructing unit 122e, and a knowledge point relation constructing unit 123e.

The knowledge point category constructing unit 121e used is for editing a category to which a current knowledge point belongs. The category of the knowledge point refers to the category defined on the knowledge point by an editor of the knowledge point. For example, “Belt and Road” is defined to the “economics” category under the editing of user A, but may be defined to the “politics” category under the editing of user B. Different users may define a same knowledge point to different categories because of their different understandings.

The knowledge point content constructing unit 122e is used for editing a label and content of the knowledge point. The label of the knowledge point is similar to the name of the knowledge point, for example, “Belt and Road” is the label of the knowledge point. The content of the knowledge point is the specific definition on the knowledge point, for example, what the Belt and Road specifically refers to is the content of the “Belt and Road” label.

The knowledge point relation constructing unit 123e is used for editing a relation between the current knowledge point and other knowledge points. The relation herein refers to a logical relation between knowledge points, and such logical relation may be preferably represented by a tree data structure. A parent-child node is used to represent a hyponymy relation between knowledge points, and a brother node is used to represent a parallel relation between knowledge points. For example, a parent node of “Belt and Road” is “national strategies”, child nodes of “Belt and Road” are “Silk Road Economic Belt”, “Maritime Silk Road”, and “AIIB”, and brother nodes of “Belt and Road” are “Beijing-Tianjin-Hebei Integration”, “Yangtze River Economic Zone”, “Free Trade Zone”, “Western Development”, “Northeast Revitalization”, and the like.

In addition, preferably, the knowledge point structure constructing module 12e further comprises a third-party knowledge point constructing unit 124c, which is used for editing a knowledge point belonging to a third party. For example, the users may edit the knowledge points in Baidupedia by the unit, and add the knowledge points to their own knowledge point structures.

For the labels and content of the knowledge points, the categories of the knowledge points, and the relations of the knowledge point, the users may set a public attribution of related information that belongs to their own knowledge points, for example, only visible to the users, only visible to fans, or completely public.

Data of the knowledge point structure (comprising the categories, the relationships, the labels, and the content of the knowledge points) is uploaded, by using the first transmission module 13e, to the server 2e for storage.

Preferably, besides the knowledge point structures processed by the users, the network terminal 1e may further provide a function of recording user's learning processes. For example, a user learning record module 14e is provided in the network terminal 1e, and is used for storing reading records of the users, comprising knowledge points, electronic books, PPT teaching materials and the like that have been read. Generally, the reading records of the users are stored according to a time sequence, and besides being stored locally, the record may be further uploaded, by the first transmission module 13e, to the server 2e for storage.

Data uploaded by many network terminals 1e and belonging to a knowledge point structure constructed by each user is uniformly stored in the knowledge point storage module 22e of the server 2e.

The users may search the network terminal 1e, and input a search condition for a target knowledge point by the search request module 11e. The system generates a search request based on the search condition, and uploads the search request to the server 2e by the first transmission module 13e.

The search processing module 21e of the server 2e processes the search request, searches the knowledge point storage module 22e based on the search request, and transmits back a search result to the network terminal 1e by using the second transmission module 23e.

In this embodiment, the search processing module 21e comprises a single knowledge point search unit 211e and a knowledge point relation search unit 213e.

The single knowledge point search unit 211e searches, by using a single knowledge point as an input condition, for labels and content of knowledge points that match the single knowledge point.

Because all the users have their own knowledge point structures on the server, multiple search results may exist. For example, when the users input the knowledge point of “AIIB”, three search results are generated. The first one is a knowledge point constructed by user A, the content of “AIIB” is obtained when user A reads an economics electronic book, and user A uses the definition of “AIIB” in the electronic book as the content of the knowledge point. The second one is a knowledge point constructed by user B, the content of “AIIB” is obtained when user B reads a current politics electronic magazine, and user B uses the definition of “AIIB” in the electronic magazine as the content of the knowledge point. The third one is a vocabulary entry of

“AIIB” from the third-party Baidupedia.

Certainly, among the knowledge points provided by the users or the third party, the system may provide one of the knowledge points which is approved by the system as the recommended knowledge point to the users.

The server 2e feeds back all search results to the network terminal 1e. Preferably, a search result prioritizing unit 212e is provided in the search processing module 21e, to prioritize the search results in a preset prioritizing condition. In this embodiment, by the number of clicks of the knowledge points, all found knowledge points are prioritized in descending order and then output. Therefore, the users can see, on the network terminal 1e, all knowledge points of “AIIB” obtained through search, and the knowledge points prioritized by the number of clicks by the users. Preferably, the number of clicks may be marked in the search results. Alternatively, the search result prioritizing unit 212e performs prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

A user following module 15e which is used for following satisfied knowledge point labels and content after the users finish reading the knowledge points in the search results may be further designed on the network terminal 1e. The following behavior is automatically uploaded to the server 2e for storage. Correspondingly, the contribution storage module 24e of the server 2e updates followed objects of the knowledge point labels and content in the knowledge point structure to which corresponding users belong, where the labels and content are stored in the contribution storage module 24e.

On this basis, a relationship is established between a user following a knowledge point and a user to which the knowledge point belongs. The system may use the relationship to make users interact with each other, thereby establishing a social relation on the network.

Moreover, if the users select, from the search results, a knowledge point provided by a third party, the search apparatus of the present invention will be a bridge and an intermediation platform between the users and a third-party knowledge point provider which directly links to the third party, for example, Baidupedia or other search websites.

In this embodiment, the knowledge point relation search unit 213e searches, by using at least two knowledge points as an input, for a relationship between the at least two knowledge points. Alternatively, the knowledge point relation search unit 213e searches, by using a single knowledge point as an input, for other knowledge points related to the single knowledge point. The relationship may not be limited, which may be, for example, a parent node knowledge point, a child node knowledge point, or a brother node knowledge point; or the relationship may be limited, which may be, for example, specifically limited to a parent node knowledge point, a child node knowledge point, or a brother node knowledge point.

Because all the users have their own knowledge point structures on the server, multiple search results may exist. For example, when users input “AIIB Belt and Road”, three search results are generated. The first one is a knowledge point relation constructed by user A, “AIIB” and “Belt and Road” are in a parent-child relation, wherein “Belt and Road” is a parent node, “AIIB” is a child node. The second one is a knowledge point relation constructed by user B, “AIIB” and “Belt and Road” are in a brother relation. The third one a skip parallel relation from the third-party Baidupedia. Certainly, the relation between “AIIB” and “Belt and Road” may not be found, in this case, the search result will represent “no relation”.

Certainly, among the knowledge point relations provided by the users or the third party, the system may provide one of the knowledge point relations which ise approved by the system, as the recommended knowledge point relation to the users.

The server 2e feeds back all search results to the network terminal 1e. The search result prioritizing unit 212e prioritizes the search results in a preset prioritizing condition. In this embodiment, by the number of clicks of the knowledge point relations, all found knowledge point relations are prioritized in descending order and then output. Therefore, the users can see, on the network terminal 1e, all relations between “AIIB” and “Belt and Road” obtained through search, and the relations prioritized by the number of clicks by the users. Preferably, the number of clicks may be marked in the search results. Alternatively, the search result prioritizing unit 212e performs prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

The user following module 15e follows satisfied knowledge point relations after the users finish reading the knowledge point relations in the search results. The following behavior is automatically uploaded to the server 2e for storage. Correspondingly, the contribution storage module 24e of the server 2e updates followed objects of the knowledge point relations in the knowledge point structure to which corresponding users belong, where the relations are stored in the contribution storage module 24e.

On this basis, a relationship is established between a user following a knowledge point relation and a user to which the knowledge point relation belongs. The system may use the relationship to make users interact with each other, thereby establishing a social relation on the network.

Moreover, if the users select, from the search results, a knowledge point relation provided by a third party, the search apparatus of the present invention will be a bridge and an intermediation platform between the users and a third-party knowledge point provider which directly links to the third party, for example, Baidupedia or other search websites.

### A Sixth Embodiment of a Knowledge Point Structure-Based Search Apparatus

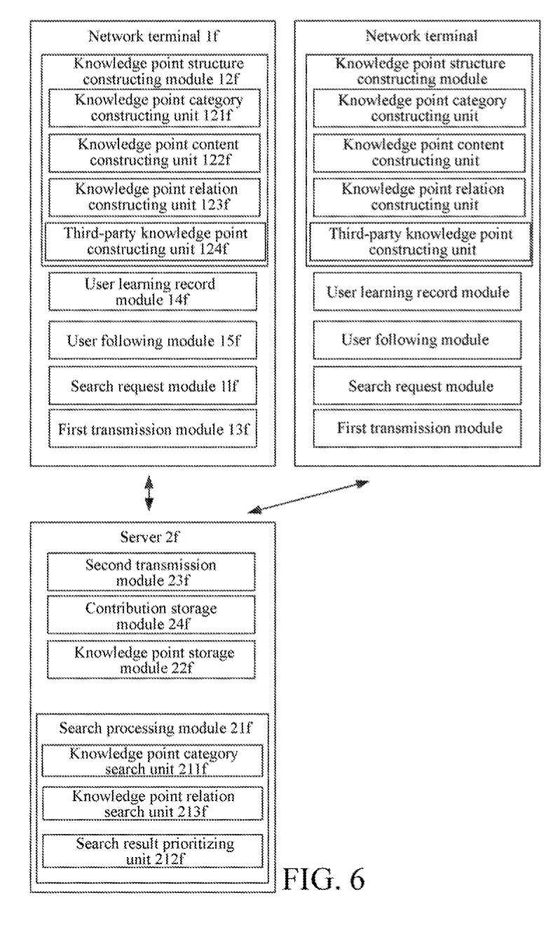

FIG. 6 shows a principle of a sixth embodiment of a knowledge point structure-based search apparatus of the present invention. Referring to FIG. 6, the knowledge point structure-based search apparatus of this embodiment comprises a network terminal 1f and a server 2f. The network terminal 1f comprises a search request module 11f, a knowledge point structure constructing module 12f, and a first transmission module 13f. The server 2f comprises a search processing module 21f, a knowledge point storage module 22f, and a second transmission module 23f.

The first transmission module 13f of the network terminal 1f transmits data with the server 2f, and the second transmission module 23f of the server 2f transmits data with the network terminal 1f.

In the knowledge point structure constructing module 12f of the network terminal 1f, users may construct their own knowledge point structures based on knowledge points, electronic books, teaching materials and the like that have been read. The knowledge point structure comprises categories, relations, labels, and content of knowledge points. Correspondingly, the knowledge point structure constructing module 12f comprises a knowledge point category constructing unit 121f, a knowledge point content constructing unit 122f, and a knowledge point relation constructing unit 123f.

The knowledge point category constructing unit 121f is used for editing a category to which a current knowledge point belongs. The category of the knowledge point refers to the category defined on the knowledge point by an editor of the knowledge point. For example, “Belt and Road” is defined to the “economics” category under the editing of user A, but may be defined to the “politics” category under the editing of user B. Different users may define a same knowledge point to different categories because of their different understandings.

The knowledge point content constructing unit 122f is used for editing a label and content of the knowledge point. The label of the knowledge point is similar to a name of the knowledge point, for example, “Belt and Road” is the label of the knowledge point. The content of the knowledge point is the specific definition on the knowledge point, for example, what Belt and Road specifically refers to is the content of the “Belt and Road” label.

The knowledge point relation constructing unit 123f is used for editing a relation between the current knowledge point and other knowledge points. The relation herein refers to a logical relation between knowledge points, and such logical relation may be preferably represented by a tree data structure. A parent-child node is used to represent a hyponymy relation between knowledge points, and a brother node is used to represent a parallel relation between knowledge points. For example, a parent node of “Belt and Road” is the “national strategies”, child nodes of “Belt and Road” are “Silk Road Economic Belt”, “Maritime Silk Road”, and “AIIB”, and brother nodes of “Belt and Road” are “Beijing-Tianjin-Hebei Integration”, “Yangtze River Economic Zone”, “Free Trade Zone”, “Western Development”, “Northeast Revitalization”, and the like.

In addition, preferably, the knowledge point structure constructing module 12f further comprises a third-party knowledge point constructing unit 124d, which is used for editing a knowledge point belongign to a third party belongs. For example, the users may edit the knowledge points in Baidupedia by the unit, and add the knowledge points to their own knowledge point structures.

For the labels and content of the knowledge points, the categories of the knowledge points, and the relations of the knowledge points, the users may set a public attribution of related information that belongs to their own knowledge points, for example, only visible to the users, only visible to fans, or completely public.

Data of the knowledge point structure (comprising the categories, the relationships, the labels, and the content of the knowledge points) is uploaded, by using the first transmission module 13f, to the server 2f for storage.

Preferably, besides the knowledge point structures processed by the users, the network terminal 1f may further provide a function of recording user's learning processes. For example, a user learning record module 14f is provided in the network terminal 1f, and is used for storing reading records of the users, comprising knowledge points, electronic books, PPT teaching materials and the like that have been read. Generally, the reading records of the users are stored according to a time sequence, and besides being stored locally, the records may be further uploaded, by the first transmission module 13f, to the server 2f for storage.

Data uploaded by many network terminals 1f and belonging to a knowledge point structure constructed by each user is uniformly stored in the knowledge point storage module 22f of the server 2b.

The users may search the network terminal 1f, and input a search condition for a target knowledge point by the search request module 11f. The system generates a search request based on the search condition, and uploads the search request to the server 2f by the first transmission module 13f.

The search processing module 21f of the server 2f processes the search request, searches the knowledge point storage module 22f based on the search request, and transmits back a search result to the network terminal 1f by using the second transmission module 23f.

In this embodiment, the search processing module 21f comprises a knowledge point category search unit 211f and a knowledge point relation search unit 213f.

The knowledge point category search unit 211f, searches, by using a single knowledge point as an input, for a category to which the single knowledge point belongs.

Because all the users have their own knowledge point structures on the server, multiple search results may exist. For example, when the users input the knowledge point of “AIIB”, three search results are generated. The first one is a knowledge point constructed by user A, the content of “AIIB” is obtained when user A reads an economics electronic book, and user A classifies “AIIB” into the “economics” category. The second one is a knowledge point constructed by user B, the content of “ AIIB” is obtained when user B reads a current politics electronic magazine, and user B classifies “AIIB” into the “politics” category. The third one is a category of “AIIB” from the third-party Baidupedia, and the category is “national strategies”.

Certainly, among the knowledge point categories provided by the users or the third party, the system may provide one of the knowledge point categories which is approved by the system as the recommended knowledge point to the users.

The server 2f feeds back all search results to the network terminal 1f. Preferably, a search result prioritizing unit 212f is provided in the search processing module 21f, to prioritize the search results in a preset prioritizing condition. In this embodiment, by the number of clicks of the knowledge point categories, all found knowledge point categories are prioritized in descending order and then output. Therefore, the users can see, on the network terminal 1f, all categories of “AIIB” obtained through search, and the categories are prioritized by the number of clicks by the users. Preferably, the number of clicks may be marked in the search results. Alternatively, the search result prioritizing unit 212f performs prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

A user following module 15f which is used for following satisfied knowledge point categories after the users finish reading the knowledge point categories in the search results may be further designed on the network terminal 1f. The following behavior is automatically uploaded to the server 2f for storage. Correspondingly, the contribution storage module 24f of the server 2f updates followed objects of the knowledge point categories in the knowledge point structure to which corresponding users belong, where the categories are stored in the contribution storage module 24f.

On this basis, a relationship is established between a user following a knowledge point category and a user to which the knowledge point category belongs. The system may use the relationship to make users interact with each other, thereby establishing a social relation on the network.

Moreover, if the users select, from the search results, a knowledge point category provided by a third party, the search apparatus of the present invention will be a bridge and an intermediation platform between the users and a third-party knowledge point provider which directly links to the third party, for example, Baidupedia or other search websites.

In this embodiment, the knowledge point relation search unit 213f searches, by using at least two knowledge points as an input, for a relationship between the at least two knowledge points. Alternatively, the knowledge point relation search unit 213f searches, by using a single knowledge point as an input, for other knowledge points related to the single knowledge point. The relationship may not be limited, which may be, for example, a parent node knowledge point, a child node knowledge point, or a brother node knowledge point; or the relationship may be limited, which may be, for example, specifically limited to a parent node knowledge point, a child node knowledge point, or a brother node knowledge point.

Because all the users have their own knowledge point structures on the server, multiple search results may exist. For example, when the users input “AIIB Belt and Road”, three search results are generated. The first one is a knowledge point relation constructed by user A, “AIIB” and “Belt and Road” are in a parent-child relation, wherein “Belt and Road” is a parent node, “AIIB” is a child node. The second one is a knowledge point relation constructed by user B, “AIIB” and “Belt and Road” are in a brother relation. The third one is a skip parallel relation from the third-party Baidupedia. Certainly, the relation between “AIIB” and “Belt and Road” may not be found, in this case, the search result will represent “no relation”.

Certainly, among the knowledge point relations provided by the users or the third party, the system may provide one of the knowledge point relations which is approved by the system, as the recommended knowledge point relation to the users.

The server 2f feeds back all search results to the network terminal 1f. The search result prioritizing unit 212f prioritizes the search results in a preset prioritizing condition. In this embodiment, by the number of clicks of the knowledge point relations, all found knowledge point relations are prioritized in descending order and then output. Therefore, the users can see, on the network terminal 1f, all relations between “AIIB” and “Belt and Road” obtained through search, and the relations prioritized by the number of clicks by the users. Preferably, the number of clicks may be marked in the search results. Alternatively, the search result prioritizing unit 212f performs prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

The user following module 15f follows satisfied knowledge point relations after the users finish reading the knowledge point relations in the search results. The following behavior is automatically uploaded to the server 2f for storage. Correspondingly, the contribution storage module 24f of the server 2f updates followed objects of the knowledge point relations in the knowledge point structure to which corresponding users belong, where the relations are stored in the contribution storage module 24f.

On this basis, a relationship is established between a user following a knowledge point relation and a user to which the knowledge point relation belongs. The system may use the relationship to make users interact with each other, thereby establishing a social relation on the network.

Moreover, if the users select, from the search results, a knowledge point relation provided by a third party, the search apparatus of the present invention will be a bridge and an intermediation platform between the users and a third-party knowledge point provider which directly links to the third party, for example, Baidupedia or other search websites.

### A Seventh Embodiment of a Knowledge Point Structure-Based Search Apparatus

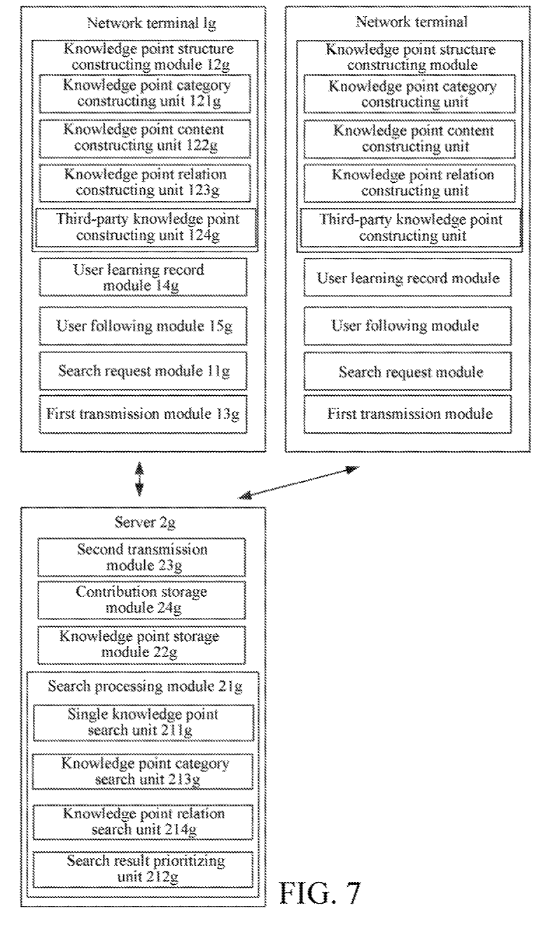

FIG. 7 shows a principle of a seventh embodiment of a knowledge point structure-based search apparatus of the present invention. Referring to FIG. 7, the knowledge point structure-based search apparatus of this embodiment comprises a network terminal 1g and a server 2g. The network terminal 1g comprises a search request module 11g, a knowledge point structure constructing module 12g, and a first transmission module 13g. The server 2g comprises a search processing module 21g, a knowledge point storage module 22g, and a second transmission module 23g.

The first transmission module 13g of the network terminal 1g transmits data with the server 2g, and the second transmission module 23g of the server 2g transmits data with the network terminal 1g.

In the knowledge point structure constructing module 12g of the network terminal 1g, users may construct their own knowledge point structures based on knowledge points, electronic books, teaching materials and the like that have been read. The knowledge point structure comprises categories, relations, labels, and content of knowledge points. Correspondingly, the knowledge point structure constructing module 12g comprises a knowledge point category constructing unit 121g, a knowledge point content constructing unit 122g, and a knowledge point relation constructing unit 123g.

The knowledge point category constructing unit 121g is used for editing a category to which a current knowledge point belongs. The category of the knowledge point refers to the category defined on the knowledge point by an editor of the knowledge point. For example, “Belt and Road” is defined to the “economics” category under the editing of user A, but may be defined to the “politics” category under the editing of user B. Different users may define a same knowledge point to different categories because of their different understandings.

The knowledge point content constructing unit 122g is used for editing a label and content of the knowledge point. The label of the knowledge point is similar to a name of the knowledge point, for example, “Belt and Road” is the label of the knowledge point. The content of the knowledge point is the specific definition on the knowledge point, for example, what the Belt and Road specifically refers to is the content of the “Belt and Road” label.

The knowledge point relation constructing unit 123g is used for editing a relation between the current knowledge point and other knowledge points. The relation herein refers to a logical relation between knowledge points, and such logical relation may be preferably represented by a tree data structure. A parent-child node is used to represent a hyponymy relation between knowledge points, and a brother node is used to represent a parallel relation between knowledge points. For example, a parent node of “Belt and Road” is “national strategies”, child nodes of “Belt and Road” are “Silk Road Economic Belt”, “Maritime Silk Road”, and “AIIB”, and brother nodes of “Belt and Road” are “Beijing-Tianjin-Hebei Integration”, “Yangtze River Economic Zone”, “Free Trade Zone”, “Western Development”, “Northeast Revitalization”, and the like.

In addition, preferably the knowledge point structure constructing module 12g further comprises a third-party knowledge point constructing unit 124g, which is used for editing a knowledge point belonging to a third party. For example, the users may edit the knowledge points in Baidupedia by the unit, and add the knowledge points to their own knowledge point structures.

For the labels and content of the knowledge points, the categories of the knowledge points, and the relations of the knowledge points, the users may set a public attribution of related information that belongs to their own knowledge points, for example, only visible to the users, only visible to fans, or completely public.

Data of the knowledge point structure (comprising the categories, the relationships, the labels, and the content of the knowledge points) is uploaded, by using the first transmission module 13g, to the server 2g for storage.

Preferably, besides the knowledge point structures processed by the users, the network terminal 1g may further provide a function of recording user's learning processes. For example, a user learning record module 14g is provided in the network terminal 1g, and is used for storing reading records of the users, comprising knowledge points, electronic books, PPT teaching materials and the like that have been read. Generally, the reading records of the users are stored according to a time sequence, and besides being stored locally, the records may be further uploaded, by the first transmission module 13g, to the server 2g for storage.

Data uploaded by many network terminals 1g and belonging to a knowledge point structure constructed by each user is uniformly stored in the knowledge point storage module 22g of the server 2g.

The users may search the network terminal 1g, and input a search condition for a target knowledge point by the search request module 11g. The system generates a search request based on the search condition, and uploads the search request to the server 2g by the first transmission module 13g.

The search processing module 21g of the server 2g processes the search request, searches the knowledge point storage module 22g based on the search request, and transmits back a search result to the network terminal 1g by using the second transmission module 23g.

In this embodiment, the search processing module 21g comprises a single knowledge point search unit 211g, a knowledge point category search unit 213g, and a knowledge point relation search unit 214g.

The single knowledge point search unit 211g searches, by using a single knowledge point as an input condition, for labels and content of knowledge points that match the single knowledge point.

Because all users have their own knowledge point structures on the server, multiple search results may exist. For example, when the users input the knowledge point of “AIIB”, three search results are generated. The first one is a knowledge point constructed by user A, the content of “AIIB” is obtained when user A reads an economics electronic book, and user A uses the definition of “AIIB” in the electronic book as the content of the knowledge point. The second one is a knowledge point constructed by user B, the content of “AIIB” is obtained when user B reads a current politics electronic magazine, and user B uses the definition of “AIIB” in the electronic magazine as the content of the knowledge point. The third one is a vocabulary entry of “AIIB” from the third-party Baidupedia.

Certainly, among the knowledge points provided by the users or the third party, the system may provide one of the knowledge points which is approved by the system, as the recommended knowledge point to the users.

The server 2g feeds back all search results to the network terminal 1g. Preferably, a search result prioritizing unit 212g is provided in the search processing module 21g, to prioritize the search results in a preset prioritizing condition. In this embodiment, by the number of clicks of the knowledge points, all found knowledge points are prioritized in descending order and then output. Therefore, the users can see, on the network terminal 1g, all knowledge points of “AIIB” obtained through search, and the knowledge points prioritized by the number of clicks by the users. Preferably, the number of clicks may be marked in the search results. Alternatively, the search result prioritizing unit 212g performing prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

A user following module 15g, which is used for following satisfied knowledge point labels and content after the users finish reading the knowledge points in the search results may be further designed on the network terminal 1d. The following behavior is automatically uploaded to the server 2g for storage. Correspondingly, the contribution storage module 24g of the server 2g updates followed objects of the knowledge point labels and content in the knowledge point structure to which corresponding users belong, where the labels and content are stored in the contribution storage module 24g.

On this basis, a relationship is established between a user following a knowledge point and a user to which the knowledge point belongs. The system may use the relationship to make users interact with each other, thereby establishing a social relation on the network.

Moreover, if the users select, from the search results, a knowledge point provided by a third party, the search apparatus of the present invention will be a bridge and an intermediation platform between the users and a third-party knowledge point provider which directly links to the third party, for example, Baidupedia or other search websites.

The knowledge point category search unit 213g, searches, by using a single knowledge point as an input, for a category to which the single knowledge point belongs.

Because all the users have their own knowledge point structures on the server, multiple search results may exist. For example, when users input the knowledge point of “AIIB”, three search results are generated. The first one is a knowledge point constructed by user A, the content of “AIIB” is obtained when user A reads an economics electronic book, and user A classifies “AIIB” into the “economics” category. The second one is a knowledge point constructed by user B, the content of “AIIB” is obtained when user B reads a current politics electronic magazine, and user B classifies “AIIB” into the “politics” category. The third one is a category of “AIIB” from the third-party Baidupedia, and the category is “national strategies”.

Certainly, among the knowledge point categories provided by the users or the third party, the system may provide one of the knowledge point categories which is approved by the system as the recommended knowledge point to the users.

The server 2g feeds back all search results to the network terminal 1g. The search result prioritizing unit 212g prioritizes the search results in a preset prioritizing condition. In this embodiment, by the number of clicks of the knowledge point categories, all found knowledge point categories are prioritized in descending order and then output. Therefore, the users can see, on the network terminal 1g, all categories of “AIIB” obtained through search, and the categories prioritized by the number of clicks by the users. Preferably, the number of clicks may be marked in the search results. Alternatively, the search result prioritizing unit 212g performing prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

The user following module 15g follows satisfied knowledge point categories after the users finish reading the knowledge point categories in the search results, and the following behavior is automatically uploaded to the server 2g for storage. Correspondingly, the contribution storage module 24g of the server 2g updates followed objects of the knowledge point categories in the knowledge point structure to which corresponding users belong, where the categories are stored in the contribution storage module 24g.

On this basis, a relationship is established between a user following a knowledge point category and a user to which the knowledge point category belongs. The system may use the relationship to make users interact with each other, thereby establishing a social relation on the network.

Moreover, if the users select, from the search results, a knowledge point category provided by a third party, the search apparatus of the present invention will be a bridge and an intermediation platform between the users and a third-party knowledge point provider which directly links to the third party, for example, Baidupedia or other search websites.

In this embodiment, the knowledge point relation search unit 214g searches, by using at least two knowledge points as an input, for a relationship between the at least two knowledge points. Alternatively, the knowledge point relation search unit 214g searches, by using a single knowledge point as an input, for other knowledge points related to the single knowledge point. The relationship may not be limited, which may be, for example, a parent node knowledge point, a child node knowledge point, or a brother node knowledge point; or the relationship may be limited, which may be, for example, specifically limited to a parent node knowledge point, a child node knowledge point, or a brother node knowledge point.

Because all the users have their own knowledge point structures on the server, multiple search results may exist. For example, when the users input “AIIB Belt and Road”, three search results are generated. The first one is a knowledge point relation constructed by user A, “AIIB” and “Belt and Road” are in a parent-child relation, wherein “Belt and Road” is a parent node, “AIIB” is a child node. The second one is a knowledge point relation constructed by user B, “AIIB” and “Belt and Road” are in a brother relation. The third one is a skip parallel relation from the third-party Baidupedia. Certainly, the relation between “AIIB” and “Belt and Road” may not be found, in this case, the search result will represent “no relation”.

Certainly, among the knowledge point relations provided by the users or the third party, the system may provide one of the knowledge point relations which is approved by the system, as the recommended knowledge point relation to the users.

The server 2g feeds back all search results to the network terminal 1g. The search result prioritizing unit 212g prioritizes the search results in a preset prioritizing condition. In this embodiment, by the number of clicks of the knowledge point relations, all found knowledge point relations are prioritized in descending order and then output. Therefore, the users can see, on the network terminal 1g, all relations between “AIIB” and “Belt and Road” obtained through search, and the relations are prioritized by the number of clicks by the users. Preferably, the number of clicks may be marked in the search results. Alternatively, the search result prioritizing unit 212g performing prioritizing based on a Page Rank algorithm of the knowledge points. The knowledge points may be referenced by the users, similar to the Page Rank algorithm, or through other explicit or implicit user behaviors, each knowledge point has an authorized value. At present, the most acceptable algorithm for knowledge point ranking is Page Rank, and some variations with emphasis on the basis of Page Rank. This is to extract valuable information from big data, to filter noise information. The users may also perform modification on the basis of reference to establish knowledge points of their own versions.

The user following module 15g follows satisfied knowledge point relations after the users finish reading the knowledge point relations in the search results. The following behavior is automatically uploaded to the server 2g for storage. Correspondingly, the contribution storage module 24g of the server 2g updates followed objects of the knowledge point relations in the knowledge point structure to which corresponding users belong, where the relations are stored in the contribution storage module 24g.

On this basis, a relationship is established between a user following a knowledge point relation and a user to which the knowledge point relation belongs. The system may use the relationship to make users interact with each other, thereby establishing a social relation on the network.

Moreover, if the users select, from the search results, a knowledge point relation provided by a third party, the search apparatus of the present invention will be a bridge and an intermediation platform between the users and a third-party knowledge point provider which directly links to the third party, for example, Baidupedia or other search websites.

Although the foregoing methods are shown in figures and described as a series of actions to simplify the explanation, it should be understood and appreciated that, the methods are not limited by the sequence of the actions. According to one or more embodiments, some actions may occur in different sequences and/or occur concurrently with other actions that are from the figures or descriptions in this specification or that are not shown in the figures or descriptions in this specification but may be understood by those skilled in the art.

Those skilled in the art may further appreciate that, the various illustrative logical plates, modules, circuits, and algorithm steps described with reference to the embodiments disclosed in this specification may be implemented as electronic hardware, computer software, or a combination of them. To clearly illustrate the interchangeability of hardware and software, various illustrative components, frames, modules, circuits, and steps are generally described above in their functionality forms. Whether such functionality is implemented as hardware or software depends on specific applications and design constraints applied to the entire system. Technicians may use different manners to implement the described functionality for each specific application, but such implementation decision should not be understood as departing from the scope of the present invention.

The various illustrative logical plates, modules, and circuits described in the embodiments disclosed in this specification may be designed, by using a general processor, a digital signal processor (DSP), an application-specific integrated circuit (ASIC), a field programmable gate array (FPGA) or another programmable logic device, a discrete gate or transistor logic, or a discrete hardware component, as any combination of the functions described in this specification for implementation or execution. The general processor may be a microprocessor, but in an alternate solution, the processor may be any conventional processor, controller, microcontroller, or state machine. The processor may be further implemented as a combination of computing devices, for example, a combination of the DSP and the microprocessor, multiple microprocessors, one or more microprocessors coordinated with DSP cores, or any other such configuration.

The steps of the methods or algorithms described in the embodiments disclosed in this specification may be directly represented in hardware, a software module executed by a processor, or a combination of them. The software module may reside in a RAM, a flash memory, a ROM, an EPROM, an EEPROM, a register, a hard disk drive, a removable disk, a CD-ROM, or a storage medium in any other form known in the field. Exemplarily, the storage medium is coupled to a processor so that the processor can read and write information from/to the storage medium. In an alternate solution, the storage medium may be integrated to the processor. The processor and the storage medium may reside in the ASIC. The ASIC may reside in a user terminal. In an alternate solution, the processor and the storage medium may reside in the user terminal as discrete components.

In one or more exemplary embodiments, the described functions may be implemented in hardware, software, firmware, or any combination of them. If being implemented as a computer program product in the software, various functions may be used as one or more instructions or codes and stored in a computer readable medium or transmitted by using a computer readable medium. The computer readable medium comprises a computer storage medium and a communication medium, which comprise any medium that makes a computer program transfer from one place to another place. The storage medium may be any available medium accessed by a computer. As an example instead of a limitation, such computer readable medium may comprise a RAM, a ROM, an EEPROM, a CD-ROM or another optical disc storage, a magnetic disk storage or another magnetic storage device, or any other medium that can be used to carry or store desirable program codes in an instruction or data structure form and that can be accessed by a computer. Any connection is also fairly referred to as a computer readable medium. For example, if the software is transferred from web sites, servers, or other remote sources by using a coaxial cable, an optical fiber cable, a twisted pair, a digital subscriber line (DSL), or a wireless technology such as infrared, radio, and microwaves, the coaxial cable, optical fiber cable, twisted pair, DSL, or wireless technology such as infrared, radio, and microwaves are comprised in the definition of medium. The disk and disc used in this specification comprise a compact disc (CD), a laser disc, an optical disc, a digital versatile disc (DVD), a floppy disk, and a blue-ray disc. The disk is usually reproduces data in a magnetic manner, and the disc reproduces data in an optical manner by using a laser. The foregoing combination should also be comprised in the scope of the computer readable medium.

The previous descriptions of this disclosure are provided to enable those skilled in the art to manufacture or use this disclosure. Various modifications made to this disclosure are obvious to those skilled in the art, and the universal principle defined in this specification may be applied to other variations without departing from the spirit and scope of this disclosure. Therefore, this disclosure is not intended to be limited to the examples and designs described in this specification, but should be granted with the widest scope consistent with the principle and novelty features disclosed in this specification.

What is claimed is:

1. A knowledge point structure-based search apparatus, comprising a network terminal and a server, wherein:
the network terminal comprises:
a search request module, used for users inputting a knowledge point for searching, and submitting, by using a first transmission module, search requests to the server for processing;
a knowledge point structure constructing module, used for the users constructing their own knowledge point structures, wherein the knowledge point structure comprises categories, relations, labels, and content of knowledge points, and uploading, by using the first transmission module, the constructed knowledge point structures to the server for storage; and
the first transmission module, used for transmitting data with the server; and
the server comprises:
a search processing module, used for searching in a knowledge point storage module of the server based on the search requests uploaded by the network terminal, and feeding back search results to the network terminal by using a second transmission module;
the knowledge point storage module, used for storing the knowledge point structures constructed by each of the users; and
the second transmission module, used for transmitting data with the network terminal.

2. The knowledge point structure-based search apparatus according to claim 1, wherein the search processing module comprises:
a search result prioritizing unit, used for prioritizing the search results.

3. The knowledge point structure-based search apparatus according to claim 1, wherein the network terminal further comprises:
a user learning record module, used for storing reading records of the users.

4. The knowledge point structure-based search apparatus according to claim 1, wherein the knowledge point structure constructing module comprises:
a knowledge point category constructing unit, used for editing a category to which a current knowledge point belong;
a knowledge point content constructing unit, used for editing a label and content of the knowledge point; and
a knowledge point relation constructing unit, used for editing relation between the current knowledge point and other knowledge points.

5. The knowledge point structure-based search apparatus according to claim 4, wherein the knowledge point structure constructing module further comprises:
a third-party knowledge point constructing unit, used for editing a knowledge point belonging to a third party.

6. The knowledge point structure-based search apparatus according to claim 1, wherein the search processing module comprises:
a single knowledge point search unit, used for searching, by using a single knowledge point as an input, for labels and content of knowledge points that match the single knowledge point.

7. The knowledge point structure-based search apparatus according to claim 1, wherein the search processing module comprises:
a knowledge point category search unit, used for searching, by using a single knowledge point as an input, for a category to which the single knowledge point belongs.

8. The knowledge point structure-based search apparatus according to claim 1, wherein the search processing module comprises:
a knowledge point relation search unit, used for searching, by using at least two knowledge points as an input, for a relationship between the at least two knowledge points; or searching, by using a single knowledge point as an input, for other knowledge points related to the single knowledge point.

9. The knowledge point structure-based search apparatus according to claim 2, wherein the search result prioritizing unit is used for prioritizing the search results in descending order by the number of clicks.

10. The knowledge point structure-based search apparatus according to claim 2, wherein the search result prioritizing unit is used for prioritizing the search results based on a Page Rank algorithm of the knowledge points.

11. The knowledge point structure-based search apparatus according to claim 1, wherein the network terminal comprises:
a user following module, used for following knowledge point labels, knowledge point relations, or knowledge point categories belonging to other users in the search results, and uploading the following information to the server.

12. The knowledge point structure-based search apparatus according to claim 1, wherein the server comprises:
a contribution storage module, used for storing a followed object of a knowledge point label, a knowledge point category, and a knowledge point relation belonging to h each user in a knowledge point structure.
